(19) United States
(12) Patent Application Publication
(10) Pub. No.: US 2025/0172027 A1
(43) Pub. Date: May 29, 2025

(54) TILTING DOOR ASSEMBLY

(71) Applicant: Craig John BUIST, Dunedin (NZ)

(72) Inventor: Craig John BUIST, Dunedin (NZ)

(21) Appl. No.: 18/959,322

(22) Filed: Nov. 25, 2024

(30) Foreign Application Priority Data
Nov. 24, 2023 (NZ) 805947

(51) Int. Cl. E05D 15/38; E05F 1/04

(52) U.S. Cl. CPC E05D 15/38; E05F 1/04; E05Y 2201/474; E05Y 2201/654; E05Y 2201/662; E05Y 2400/40; E05Y 2400/44; E05Y 2900/108

(57) ABSTRACT

A tilting door assembly having a door frame and a door leaf arranged to move from a vertical closed position to a horizontal open position about a horizontal tilt axis. A plurality of fixed guide tracks guide movement of the door leaf between the open and closed positions. A counterweight is provided, with a sheave and cable system arranged between the door leaf and the counterweight and a winch coupled to the counterweight via a winch cable. The winch is operable to open and close the door such that raising the counterweight moves the door towards the closed position, and lowering the counterweight moves the door towards the open position. The counterweight has a mass that is greater than a mass of the door leaf.

### FIELD OF THE INVENTION

This invention relates to a tilting door assembly, in particular a vertically tilting door assembly for a hanger or other large building.

### BACKGROUND

Vertically tilting doors are commonly used on buildings such as aircraft hangers and garages that have large openings, for example, for vehicles. Mechanisms for operating vertically tilting doors include components positioned inside the building, typically above the top of the door frame. In some mechanisms, significant space above the door frame is required to accommodate components and, thus, a sufficiently high roof height is required.

For low-profile buildings, the requirement for above door-frame space to accommodate door mechanisms may limit the maximum height of the door opening. For a given size door opening, it may mean vertically tilting doors are not a feasible door solution where there is insufficient clearance above the door frame.

Operation of vertically tilting doors can also present some safety hazards. For large openings, the door leaf can be very heavy and present a significant hazard if it were to fall or hit a person or object as it is moving into a closed position.

It is an object of at least preferred embodiments of the present invention to address one or more of the above-mentioned disadvantages and/or to at least provide the public with a useful alternative.

In this specification where reference has been made to patent specifications, other external documents, or other sources of information, this is generally to provide a context for discussing features of the invention. Unless specifically stated otherwise, reference to such external documents or sources of information is not to be construed as an admission that such documents or such sources of information, in any jurisdiction, are prior art or form part of the common general knowledge in the art.

In this specification, the term ‘vertically tilting door’ is used to refer to a door that tilts about a horizontal tilt axis. The tilt axis may move or remain stationary as the door tilts.

### SUMMARY OF THE INVENTION

In a first aspect, the present invention provides a tilting door assembly comprising a door frame, a door leaf, a plurality of guide tracks fixed relative to the frame, a counterweight, and a sheave and cable system arranged between the door leaf and the counterweight. The door leaf is arranged to move from a substantially vertical closed position to a substantially horizontal open position, the leaf having a horizontal tilt axis. The guide tracks are configured to guide movement of the door leaf between the open and closed positions. A winch is coupled to the counterweight via a winch cable and operable to open and close the door, whereby raising the counterweight moves the door towards the closed position, and lowering the counterweight moves the door towards the open position. The counterweight has a mass that is greater than a mass of the door leaf.

The door assembly may comprise a load sensor, wherein the load sensor is coupled to the winch cable and configured to sense tensile forces in the winch cable.

The winch cable may extend from the winch to the load sensor via the counterweight, the counterweight comprising a moving pulley.

In an embodiment, the load sensor and the winch are positioned above the counterweight.

In an embodiment, the load sensor comprises a spring and is configured to measure the spring force and/or displacement of the spring. The spring may comprise a compression spring. In some embodiments the load sensor may include more than one spring, for example a primary spring and a secondary spring. The secondary spring may have a lower spring constant than the primary spring and be longer than the primary spring.

The door assembly may include a controller, configured to stop or reverse movement of the winch when tensile forces exceed a predetermined value.

In an embodiment, the counterweight has a mass that is at least 80 kg or 100 kg or 120 kg greater than a mass of the door leaf. In an embodiment the counterweight has a mass that is at least 110% of the mass of the door leaf, for example 110% to 140% of a mass of the door, preferably about 115% to about 125% of the mass of the door.

In an embodiment, the sheave and cable system comprises a plurality of door cables, each door cable having a first end fixed to the door leaf at a respective cable connection point. Each door cable may pass through an aperture in the door leaf.

In an embodiment, the door leaf comprises a support frame, each door cable first end being coupled to a respective member of the support frame.

A plurality of door cable routing brackets may be mounted to respective framing members, to facilitate the connection of the door cables to the respective framing members through a range of relative door cable angles. Each door cable routing bracket may comprise a routing portion to receive the respective door cable, the routing portion at least partly protruding through the door leaf. The routing portion may comprise an arcuate groove to receive the respective door cable and to allow the cable to bend through about 90 degrees along the routing portion.

In an embodiment, the door assembly includes a plurality of door cable sheaves, each configured to receive one or more door cables. Each door cable sheave may be positioned substantially directly above the respective cable connection point. The door cable sheaves may be positioned on or slightly above a top member of the door frame.

In an embodiment, a first fixed sheave may be provided, positioned generally above the counterweight, to route the door cables down to the counterweight.

In an embodiment, a second fixed sheave may be provided to route cables from the door cable sheaves to the first sheave.

In an embodiment, the door cable sheaves, the first sheave, and the second sheave are all mounted at substantially the same height relative to the door frame.

In an embodiment, the door cable sheaves are rotatable about a first axis of rotation, the first sheave is rotatable about a second axis of rotation, and the second sheave is rotatable about a third axis of rotation; wherein the first, second, and third axes of rotation are mutually perpendicular.

In an embodiment, the guide tracks include a plurality of curved top guide tracks positioned at or above a top of the door frame, and wherein the door leaf comprises a plurality of guide members at a top of the door leaf for receipt by the curved top guide tracks.

In an embodiment, the guide tracks include two vertical side guide tracks at opposite sides of the door frame, and wherein the door leaf comprises two respective side guide members for receipt by the side guide tracks. Preferably, the door leaf side guide members are co-axial and positioned on the tilt axis, and wherein the door leaf side guide members are rotatable about the tilt axis within the side guide tracks and vertically slidable.

In an embodiment, in the open position at least a portion of the door leaf protrudes forward of the door frame. For example, between about 30% and about 60% of the door leaf may protrude, for example 50%.

In an embodiment, the door assembly has a mullion pivotally attached to the door leaf at the tilt axis, the mullion being movable between an extended position and a retracted position. In some embodiments, two or more doors may be arranged side-by-side, each door having at least one edge pivotally attached at its tilt axis to a respective movable mullion.

This invention may also be said broadly to consist in the parts, elements and features referred to or indicated in the specification of the application, individually or collectively, and any or all combinations of any two or more said parts, elements, or features. Where specific integers are mentioned herein which have known equivalents in the art to which this invention relates, such known equivalents are deemed to be incorporated herein as if individually described.

The term ‘comprising’ as used in this specification and claims means ‘consisting at least in part of’. When interpreting statements in this specification and claims that include the term ‘comprising’, other features besides those prefaced by this term can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range and any range of rational numbers within that range (for example, 1 to 6, 1.5 to 5.5 and 3.1 to 10). Therefore, all sub-ranges of all ranges expressly disclosed herein are hereby expressly disclosed.

As used herein the term ‘(s)’ following a noun means the plural and/or singular form of that noun. As used herein the term ‘and/or’ means ‘and’ or ‘or’, or where the context allows, both.

### BRIEF DESCRIPTION OF THE DRAWINGS

The present invention will now be described by way of example only and with reference to the accompanying drawings in which:

FIG. 1 is a schematic perspective view of one embodiment of a tilting door assembly in a partly open configuration;

FIG. 2 is a front elevation view of the door assembly of FIG. 1, in an open position;

FIG. 3 is a front elevation view of the door assembly of FIGS. 1 and 2, in a closed position;

FIG. 4 is a schematic view of a winch assembly for operating the door of FIGS. 1 to 3;

FIG. 5 is an elevation view of an attachment bracket for coupling a door cable to the door leaf in the door assembly of FIGS. 1 to 3;

FIG. 6 is a front elevation schematic view of a building having two individually operable doors arranged side-by-side over a single opening; and

FIG. 7 is a sectional side view through the assembly of FIG. 6, showing operation of one door the respective movable mullion.

### DETAILED DESCRIPTION OF A PREFERRED EMBODIMENT

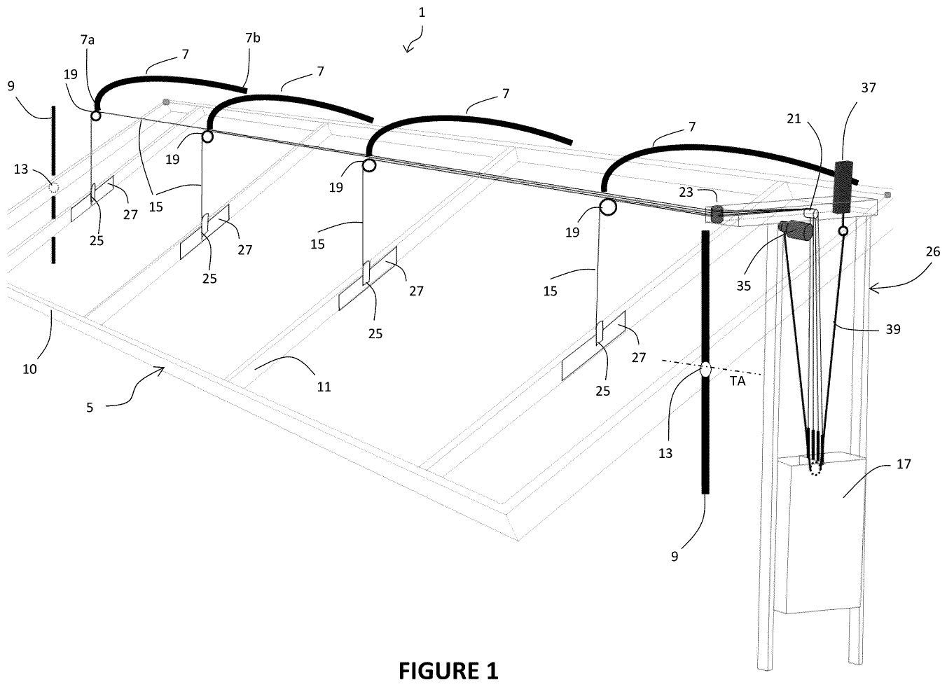

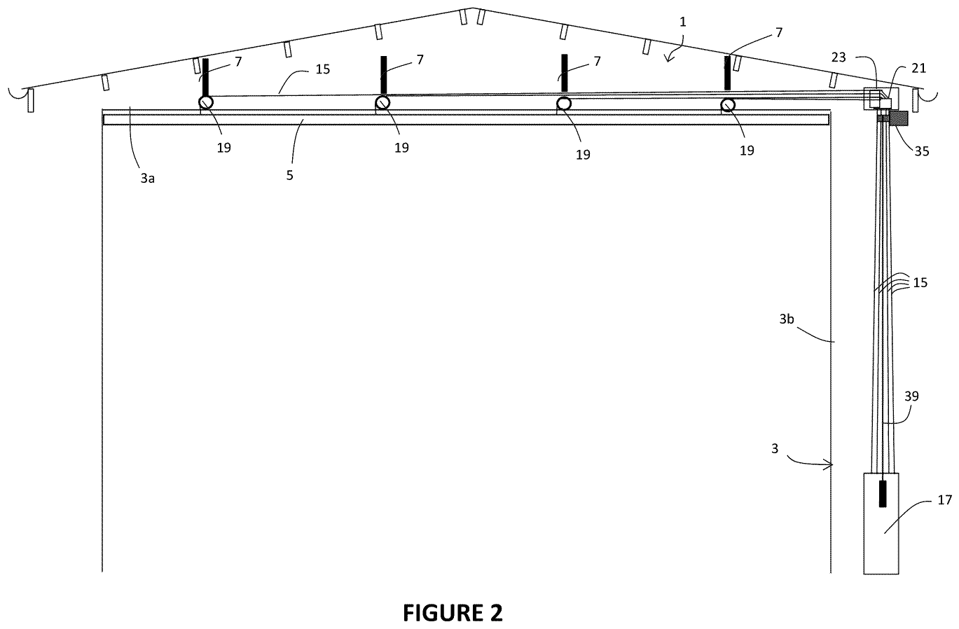

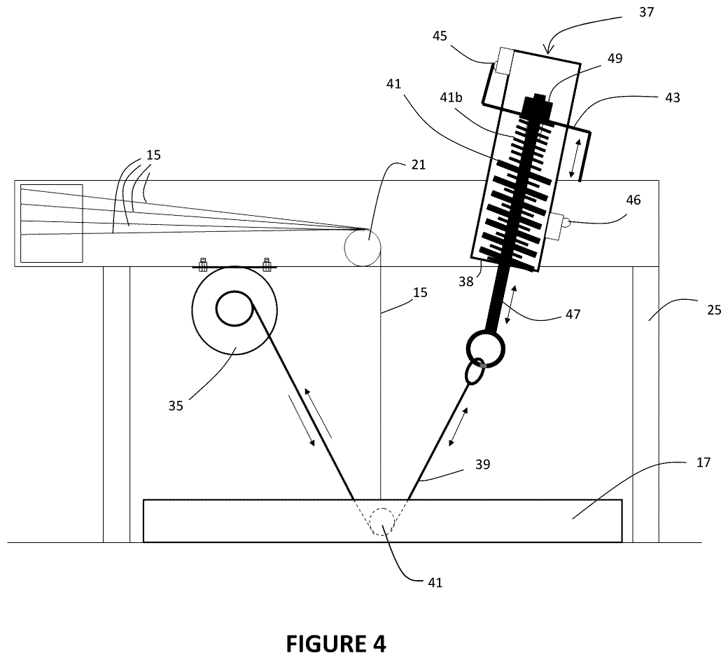

While the present invention may be embodied in many different forms, for the purpose of promoting an understanding of the principles of the present invention, reference will now be made to FIGS. 1 to 5, which show an exemplary embodiment tilting door assembly 1.

Referring to FIGS. 1 to 3, the tilting door assembly 1 described herein comprises a door frame 3, a door leaf 5 arranged to move from a substantially vertical closed position to a substantially horizontal open position. A plurality of guide tracks 7, 9 are fixed relative to the frame 3 and configured to guide movement of the door leaf 5 between the open and closed positions.

The door frame 3 is fixed to a building and defines the door opening. The door frame 3 comprises top and side members fixed to the building, typically to define a rectangular opening. In the embodiment shown and for most applications, the width of the door frame 3 is greater than the height of the door frame. For example, the width may be more than 150% or more than 200% the height of the door frame.

The door leaf 5 is a rectangular member, movable relative to the door frame 3. The shape of the door leaf 5 corresponds to that of the door frame, typically being a rectangular member. In the embodiment shown and for most applications, the width of the door leaf 5 is greater than the height of the door leaf 5. For example, the width may be more than 2 times or more than 10 times the height of the door leaf.

The door leaf 5 may comprise a support frame 10, for example with a support frame comprising plurality of support struts 11 that support front cladding (not shown). The support frame may be any suitable material such as timber or metal, for example. The front cladding may comprise one or more planar members of a suitable material such as timber, steel, aluminium, for example.

Movement of the door leaf 5 relative to the building is constrained and guided by a plurality of top guide tracks 7. These top guide tracks 7 are positioned internally within the building, generally above the door opening. The guide tracks 7 are attached at a first end 7a to the building or door frame, at a point at or above the top of the door frame 3.

The door leaf 5 comprises a plurality of top guide members (not shown), for example carriages and/or rollers, for receipt by the top guide tracks 7.

The top guide tracks 7 each define a rail, channel, or other track to slidably receive the complementary top guide members on the door leaf 5. For example, the top guide tracks 7 may each comprise a channel that receives a roller from carriages mounted to the top of the door leaf, the rollers being movable along the respective track as the door is opened and closed.

A second end 7b of each top guide track projects inwardly into the building. The top guide tracks 7 may be cantilevered members, cantilevered from their first ends (door frame ends) 7a. Optionally, there may be one or more supports to support the distal ends of the guide tracks relative to the frame or roof of the building. These supports may attach to the top guide tracks at or near the second ends 7b, and/or at or near a mid-point of the track.

The top guide tracks 7 are curved with a curvature that varies along the length of the track. In the exemplary embodiment, the tracks 7 each have a tighter curvature at their first ends 7a, near the door frame, and a lesser curvature distal to the door frame towards the second end 7b.

The curvature is designed such that the force transmitted by the rollers of the top guide members as at a slight angle to the track to urge movement the rollers along the track. If the curvature is such that the angle is too shallow or perpendicular to the track at any point, the door may be susceptible to stalling during opening.

In the embodiment shown, the door assembly 1 includes four top guide members 7, however, in alternative embodiments there may be more or fewer top guide tracks depending on the size and mass of the door. The top guide tracks 7 are parallel members each following the same curvature such that the door leaf guide members are coaxial and move along all of the top guide tracks 7 in tandem.

The second end 7b may be at substantially the same height or slightly below the first end 7a to facilitate holding the door leaf 5 in a horizontal position at the top of the door opening.

In some embodiments, the second end 7b of the top guide track 7 may include a stop to limit movement of the door leaf guide members along the track. The stop may define the open position of the door, for example being at substantially the same height or slightly below the top member 3a of the door frame 3. Alternatively, the movement of the door along the tracks may be limited by the top of the door frame.

The assembly 1 further includes two vertical side guide tracks 9 provided at opposite sides of the door frame 3. These side guide tracks 9 constrain movement of the door leaf 5, causing it to tilt as the door leaf top guide members move along the top guide tracks 7.

The door leaf 5 comprises two coaxial side guide members 13 at opposite ends of the door leaf 5. The side guide tracks 9 each define a rail, channel, or other track to slidably receive the complementary side guide members on the door leaf 5. For example, the side guide tracks 9 may each comprise a channel.

The side guide members 13 are both rotatable and slidable relative to the side guide tracks 9 to allow the door to tilt as the side guide members move up or down in the guide tracks 9. For example, the side guide members 13 may comprise coaxial rollers, sliding blocks, or spigots.

The door leaf side guide members 13 define a tilt axis TA of the door leaf, about which the door leaf tilts as it is raised or lowered. The side guide members and thereby the tilt axis is typically provided at or near a mid-point of the door leaf, for example along a balance point of the door. In alternative embodiments, the tilt axis may be closer to the bottom of the door leaf or closer to the top of the door leaf 5.

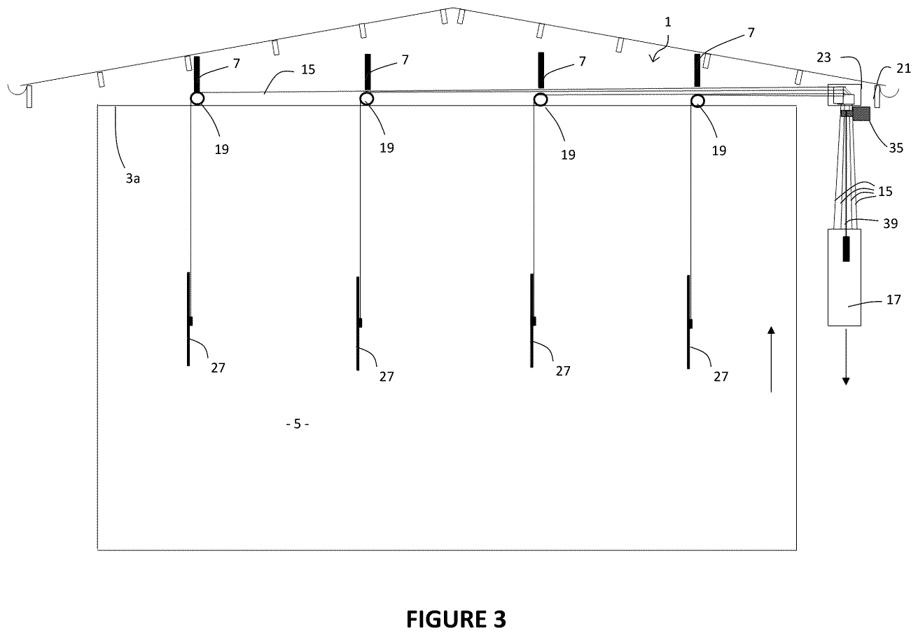

When the door leaf 5 is in the open position, it is substantially horizontal and positioned at or near the top of the door frame, as illustrated in FIG. 3. A portion of the door leaf 5 is positioned inside the building and a portion protrudes forward of the door frame 3.

The proportion of the door leaf 5 that protrudes in the open position is determined by the location of the tilt axis TA and the length of the top guide tracks 7. In some embodiments between about 30% and about 60% of the door leaf 5 may protrude, for example about 30% or about 40% or about 50% of the door leaf 5 may protrude externally from the building.

The door assembly 1 comprises a sheave and cable system arranged to open and close the door. A plurality of cables 15, 39 link the door leaf 5 with a counterweight 17 and winch 35 via a series of sheaves 19, 21, 23.

The cables include a plurality of door cables 15, each having a first end attached to the door leaf 5 at a connection point 25. In the embodiment shown, the door cables 15 connect to the door leaf support struts 11.

Each door cable 15 extends down a front (external face) of the door leaf 5 to the respective connection point 25.

The connection point 25 where the door cable 15 secures to the door leaf may be on an exterior or interior side of the door leaf 5. Preferably, and as shown in the drawings, the connection point is provided on an interior side of the door, with the door cables 15 each passing through an aperture in the cladding of the door leaf cladding from the exterior side to the interior connection point 25.

The connection point 25 may be provided on the support structure 11 of the door leaf 5. The cables 15 may be fixed directly to the support structure 11 or may be attached via a connection bracket 27 or other connector.

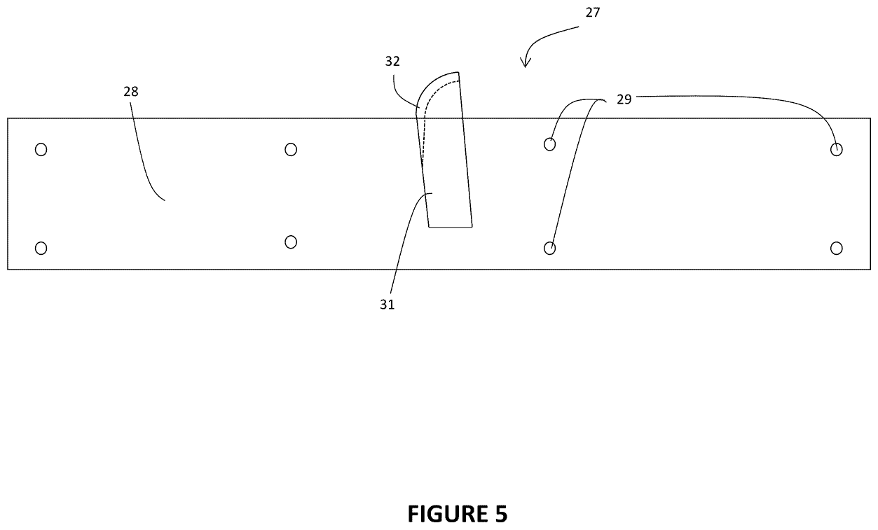

FIG. 5 shows one example connection bracket 27. The connection bracket 27 comprises an attachment portion 28 for securing the bracket 28 to the door leaf 5, and a routing portion 31 to receive a respective door cable 15. The connection bracket 27 facilitates the attachment of the respective door cable 15 to the door leaf and the routing of the cable 15 through an aperture in the door leaf to an external side of the door.

The routing portion 31 comprises an arcuate groove 33 to receive the cable 15. The groove 33 extends along an arc or curve of about 90 degrees to allow the respective door cable 15 to bend through a range of angles. In the closed position of the door, the door cable 15 bends through about 90 degrees at the connection bracket 27, between the connection point and a vertical route up the front of the door leaf 5. In the open position of the door, the door cable 15 is substantially straight at the connection bracket 27, extending vertically upwards.

The routing portion 31 at least partly protrudes through the door leaf 5 such that a portion is positioned on an exterior side of the door leaf 5. The routing portion 31 prevents the door cable 15 from rubbing against the edge of the respective door leaf aperture and spaces the cable 15 slightly forward of the door leaf 5 to prevent the cable 15 rubbing against the cladding.

Preferably the routing portion 31 only protrudes slightly through the door leaf 5, to provide sufficient clearance for the cable without substantially limiting the maximum height of the open door relative to the door frame 3. Some existing tilting door systems may use an eye bolt or other fixture system to secure cables to the door leaf, which requires significantly more clearance between the door leaf and the door frame in the open position to accommodate, reducing the maximum opening size for a given size door frame.

The sheave and cable system includes a plurality of door cable sheaves 19, each configured to receive one or more door cables 15. The door cable sheaves 19 are rotatable members that are fixed at or near the top member 3a of the door frame 3, position directly over a respective door cable connection point 25.

The door cable sheaves are positioned to the inside of the door frame. The sheaves may be slightly higher than the top of the door opening. Preferably the door cable sheaves 19 are positioned at about the same height as the first ends 7a of the top guide tracks, and preferably not higher that a highest point of the top guide tracks 7.

The door cable sheaves 19 route the door cables 15 from their vertical paths from the door cable connection point 25, through 90 degrees and sideways along a top of the door frame. The door sheaves 19 may route a single cable 15, may route multiple cables, either via a single groove or via multiple grooves corresponding to the multiple cables 15.

In the example shown, a first door sheave at a first end of the door frame distal to the counterweight 17 receives only a single cable 15. The next sheave along receives the cable from the first door sheave and the door cable 15 from the respective connection point below, etc. The sheave nearest the second end of the door frame receives n cables, where n is the number of door cables 15 and the number of door sheaves. However, other configurations are envisaged and would be apparent to a person skilled in the art.

The door cables 15 ultimately extend to the counterweight 17 via one or more further sheaves or pulleys. The door cables 15 may each extend to the counterweight, as shown in the exemplary embodiment. Alternatively, one or more or all of the door cables 15 may be joined together to another cable that is in turn coupled to the counterweight. The configuration may depend on the size of the door assembly and the number of cables, with the option of joining cables favoured in larger assemblies.

In some embodiment, the door cables 15 may be coupled to a turnbuckle or other mechanism to enable adjustment of the tension in the cable. The turnbuckles or other mechanisms may be coupled to the counterweight, for example.

In the embodiment shown, the cables 15 are routed from the horizontal path above the door frame, to the counterweight 17 via first and second fixed sheaves 21, 23.

The first fixed sheave 21 is positioned generally above the counterweight 17, to route the door cables 15 from a horizontal path, down to the counterweight 17. The first fixed sheave may be mounted to a side of the building or to the top of a counterweight tower 26, as illustrated in the present example. In the embodiment shown, the first sheave 21 may be a single or multi-grooved member to receive all four of the door cables 15, but in alternative embodiments where two or more door cables are joined, may receive a different number of cables.

The second fixed sheave 23 is positioned to route cables from the door cable sheaves 19 to the first sheave 21. In the embodiment shown, the second fixed sheave routes cables horizontally through about 90 degrees. The second fixed sheave may be mounted in a corner of the building, for example.

The door cable sheaves 19 are rotatable about a first axis of rotation, the first fixed sheave 21 is rotatable about a second axis of rotation, and the second fixed sheave 23 is rotatable about a third axis of rotation.

In the embodiment shown, the first, second, and third axes of rotation are mutually perpendicular, and the door cable sheaves 19, the first sheave 21, and the second sheave 23 are all mounted at substantially the same height relative to the top member 3a of the door frame 3. However, in alternative embodiments having different configurations of sheaves, the heights and rotation axes may vary.

The sheave arrangement in the present invention advantageously has a low profile. That is, the space the assembly utilises above the door is minimised, making the present assembly well suited to low profile buildings or for buildings where a majority of the height of the building is to be utilised for an opening.

The door assembly comprises a winch that is coupled to the counterweight 17 via a winch cable 39 and operable to raise and lower the counterweight 17. This in turn moves the door leaf 5 between the open and closed positions.

Raising the counterweight 17 moves the door towards the closed position, and lowering the counterweight moves the door towards the open position.

The assembly may further include a load sensor 37 as a safety feature for detecting variations in loading on the door leaf as it opens and closes. For example, to detect if the door has hit an object as it is closing or opening.

In the embodiment shown, the winch cable 39 extends from the winch 35 to the load sensor 37 via the counterweight 17. The counterweight comprises a moving pulley 41 to move along the cable 39. In the embodiment shown, both the load sensor 37 and the winch 35 are positioned above the counterweight 17. However, in alternative embodiments, the winch and/or load sensor may be positioned elsewhere, and the cables routed accordingly.

To raise and lower the counterweight, some load is carried by the door cables 15, and the remaining load is carried by the winch cable 39.

In the embodiment shown, a load sensor 37 comprises a spring tower with one or more compression springs 41 and is configured to measure the spring force by measuring the displacement of the compression spring(s) The spring tower 37 includes a top plate 43 or top member at a top end of the spring to which the winch cable 39 is coupled via a coupling bar 47 or eye bolt, and nut 49.

In some embodiments, the spring tower includes a first large heavy spring 41 and a lighter and smaller spring nested in the large heavy spring and extending above the heavy spring to push the contact plate 43 up when the winch cable goes slack.

The opposite end of the spring 41 is supported by and acts against a bottom end of the spring tower housing 38. In alternative embodiments, the spring tower 37 may have different configurations, for example if may instead include a tension spring and measure displacement of a member at a bottom of the tension spring.

Load from the winch cable 39 acts to compress the spring 41, pulling the top plate 43 towards the bottom of the cable housing. The load sensor 37 comprises switches or other sensors 45, 46, to detect displacement of the top plate 43.

When the tension in the winch cable 39 decreases, for example because more load is carried by the door cables 15, the spring 41 expands to move the top plate 43 upwards. A top switch or sensor 45 detects when the spring has expanded to a predetermined maximum limit. This may occur, for example, when the door has reached its open position, if it hits anything as it is opening that prevents movement towards the open position, or if door opening is attempted when the door is bolted in a closed position.

When the tension in the winch cable 39 increases, for example because less load is carried by the door cables 15, the spring 41 compresses to move the top plate 43 downwards. A bottom switch or sensor 43 detects when the spring has compresses to a predetermined maximum limit corresponding to a predetermined maximum permissible tension in the winch cable 39. This may occur, for example, when if the door hits an object as it is closing, or when the door reaches its closed position.

The door assembly 1 may include a controller, configured to stop or reverse movement of the winch when the top or bottom switches or sensors detect that the winch cable tension is outside a range of permitted values.

The counterweight 17 has a mass that is greater than a mass of the door leaf. In some embodiments the mass of the counterweight is between about 110% and about 140% of the door leaf 5, or between about 115% and about 125% of the door weight. In some embodiments the mass of the counterweight is at least about 80 kg more than the mass of the door leaf 5. In the preferred embodiment, the mass of the counterweight is about 100 kg or about 120 kg more than the mass of the door leaf 5. This heavier counterweight advantageously ensures that should a winch or winch cable fail, then the door leaf 5 will move up towards the open position rather than falling down.

The counterweight is typically housed within a shaft or guide housing for safety.

In the scenario where the spring tower failed during opening of the door, then only the difference between door mass and the counterweight would be applied to any object that were hit. Thus, providing a secondary safety backup for when the door is closing. In the scenario where the spring tower failed during closing of the door, the door closing will stall with all the weight of the door as the winch continues to raise the counterweight.

In some embodiments, the door assembly may comprise one or more other sensors linked to the controller to govern operation of the door. For example, a wind sensor in the form or a probe or other sensor may be positioned externally on the building to measure air speed or air pressure outside the building. Where the wind speed perpendicular to the door leaf exceeds a predetermined maximum, opening of the door may be prevented.

In some applications, two or more doors may be installed side-by-side across a single opening. This may be helpful where the building opening is very wide, or where it is desired to have the ability to open one side or portion of the opening while leaving another side or portion closed. In embodiments with multiple doors, movable mullions may be provided for mounting the doors.

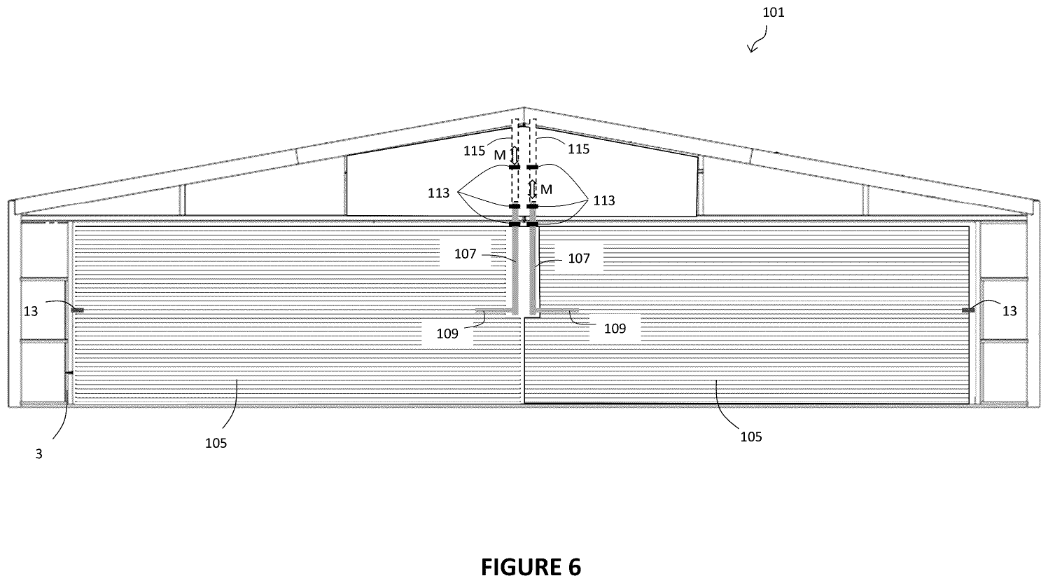

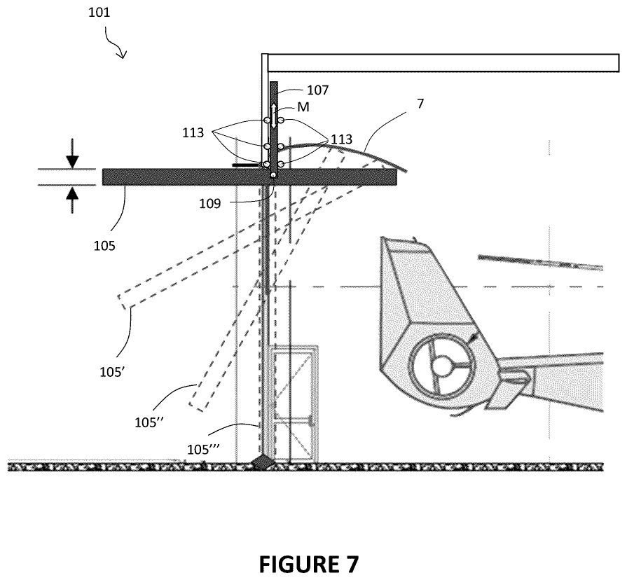

FIGS. 6 and 7 illustrate one example embodiment of an aircraft hangar 101 having two independently operable doors 105 provided over a single opening. Each door has a first edge adjacent to a side of the opening frame 3 and mounted to the frame with a guide member 13. The guide members are rotatably and slidably mounted in a respective guide track to guide the motion of the door and facilitate tilting of the door as it opens and closes, as described above.

A second edge of each door is positioned in a middle portion of the door frame 3. To support the door at this second edge, a retractable mullion 107 is provided for each door.

Each mullion 107 is pivotally attached to the respective door at a pivot axis that is co-axial with the pivot axis of the guide member 13. The mullion 107 may be attached via an axle 109, for example.

The mullions 107 are movably attached to the frame 3 and/or building to enable movement of the mullion with respect to the frame 3. The mullion may be mounted in a guide track or on other guides to constrain motion of the mullion. In the example shown, sets of rollers 113 are provided to guide the mullion in a substantially vertical direction.

The mullions may have any suitable shape or form. For example, in they may comprise rectangle hollow section steel member.

The mullions 107 are arranged are movable between an extended position and a retracted position, as illustrated in FIG. 7. In the extended position (FIG. 6), the mullion extends into the opening and supports the respective door 105 in its closed position. In the retracted position, the mullion is substantially or wholly retracted from the opening and supports the respective door 105 in its open position. Movement of a door and its mullion are illustrated in FIG. 7, where 105″ illustrates the closed door position, 105 illustrates the open door position, and 105′ and 105″ illustrate two intermediate positions.

As each door 105 opens from the closed position the door pivot attachment 109 to the mullion rises up along as the guide member 13 on the other edge of the door slides up the guide track. The Mullion moves up into the Gable above the door, guided by one or more guide members 113. As the pivots 13, 109 rise, the door tilts as the top edge is guided along the guide track 7 (not shown in FIGS. 6 and 7), as described above.

In the embodiment shown, each door has its own independently movable mullion to enable each door to be operable independent of the other door. This enables the doors to be open one-by-one to create a total clear span without the need for any pillars or fixed mullions in the door opening. In some embodiments movement of the doors may be linked.

Preferred embodiments of the invention have been described by way of example only and modifications may be made thereto without departing from the scope of the invention.

1. A tilting door assembly comprising:
a door frame;
a door leaf arranged to move from a substantially vertical closed position to a substantially horizontal open position, the leaf having a horizontal tilt axis;
a plurality of guide tracks fixed relative to the frame, configured to guide movement of the door leaf between the open and closed positions;
a counterweight;
a sheave and cable system arranged between the door leaf and the counterweight;
a winch coupled to the counterweight via a winch cable and operable to open and close the door, whereby raising the counterweight moves the door towards the closed position, and lowering the counterweight moves the door towards the open position; and
wherein the counterweight has a mass that is greater than a mass of the door leaf.

2. A tilting door assembly as claimed in claim 1, further comprising a load sensor, wherein the load sensor is coupled to the winch cable and configured to sense tensile forces in the winch cable.

3. A tilting door assembly as claimed in claim 2, wherein the winch cable extends from the winch to the load sensor via the counterweight, the counterweight comprising a moving pulley.

4. A tilting door assembly as claimed in claim 2, wherein the load sensor and the winch are positioned above the counterweight.

5. A tilting door assembly as claimed in claim 2, wherein the load sensor comprises a spring and is configured to measure the spring force and/or displacement of the spring.

6. A tilting door assembly as claimed in claim 5, wherein the spring is a compression spring.

7. A tilting door assembly as claimed in claim 1, further comprising a controller, configured to stop or reverse movement of the winch when tensile forces exceed a predetermined value.

8. A tilting door assembly as claimed in claim 1, wherein the counterweight has a mass that is at least 80 kg greater than a mass of the door leaf.

9. A tilting door assembly as claimed in claim 8, wherein the counterweight has a mass that is at about 100 kg greater than a mass of the door leaf.

10. A tilting door assembly as claimed in claim 1, wherein the counterweight has a mass that is at least about 110% of a total mass of the door leaf(s).

11. A tilting door assembly as claimed in claim 8, wherein the counterweight has a mass that is between about 110% and about 125% of a total mass of the door leaf(s).

12. A tilting door assembly as claimed in claim 1, wherein the sheave and cable system comprises a plurality of door cables, each door cable having a first end fixed to the door leaf at a respective cable connection point.

13. A tilting door assembly as claimed in claim 12, wherein each door cable passes through an aperture in the door leaf.

14. A tilting door assembly as claimed in claim 12, wherein the door leaf comprises a support frame, each door cable first end being coupled to a respective member of the support frame.

15. A tilting door assembly as claimed in claim 14, comprising a plurality of door cable routing brackets mounted to respective framing members, to facilitate the connection of the door cables to the respective framing members through a range of relative door cable angles.

16. A tilting door assembly as claimed in claim 15, wherein each door cable routing bracket comprises a routing portion to receive the respective door cable, the routing portion at least partly protruding through the door leaf.

17. A tilting door assembly as claimed in claim 16, wherein the routing portion comprises an arcuate groove to receive the respective door cable and to allow the cable to bend through about 90 degrees along the routing portion.

18. A tilting door assembly as claimed in claim 12, comprising a plurality of door cable sheaves, each configured to receive one or more door cables.

19. A tilting door assembly as claimed in claim 18, wherein each door cable sheave is positioned directly above the respective cable connection point.

20. A tilting door assembly as claimed in claim 19, wherein the door cable sheaves are positioned on or slightly above a top member of the door frame.

21. A tilting door assembly as claimed in claim 12, comprising a first fixed sheave, positioned generally above the counterweight, to route the door cables down to the counterweight.

22. A tilting door assembly as claimed in claim 21, comprising a second fixed sheave to route cables from the door cable sheaves to the first sheave.

23. A tilting door assembly as claimed in claim 22, wherein the door cable sheaves, the first sheave, and the second sheave are all mounted at substantially the same height relative to the door frame.

24. A tilting door assembly as claimed in claim 22, wherein the door cable sheaves are rotatable about a first axis of rotation, the first sheave is rotatable about a second axis of rotation, and the second sheave is rotatable about a third axis of rotation; wherein the first, second, and third axes of rotation are mutually perpendicular.

25. A tilting door assembly as claimed in claim 1, wherein the guide tracks include a plurality of curved top guide tracks positioned at or above a top of the door frame, and wherein the door leaf comprises a plurality of guide members at a top of the door leaf for receipt by the curved top guide tracks.

26. A tilting door assembly as claimed in claim 1, wherein the guide tracks include two vertical side guide tracks at opposite sides of the door frame, and wherein the door leaf comprises two respective side guide members for receipt by the side guide tracks.

27. A tilting door assembly as claimed in claim 26, wherein the door leaf side guide members are co-axial and positioned on the tilt axis, and wherein the door leaf side guide members are rotatable about the tilt axis within the side guide tracks and vertically slidable.

28. A tilting door assembly as claimed in claim 1, comprising a mullion pivotally attached to the door leaf at the tilt axis, the mullion being movable between an extended position and a retracted position.

29. A tilting door assembly as claimed in claim 28, comprising two or more doors arranged side-by-side, each door having at least one edge pivotally attached at its tilt axis to a respective movable mullion.

30. A tilting door assembly as claimed in claim 1, wherein in the open position at least a portion of the door leaf protrudes forward of the door frame.
